(19) United States
(12) Patent Application Publication
(10) Pub. No.: US 2025/0370119 A1
(43) Pub. Date: Dec. 4, 2025

(54) RADAR APPARATUS AND VEHICLE

(71) Applicant: Panasonic Automotive Systems Co., Ltd., Kanagawa (JP)

(72) Inventors: Junji SATO, Tokyo (JP); Takaaki KISHIGAMI, Tokyo (JP); Yuki TERAKADO, Kanagawa (JP); Masatoshi SUZUKI, Shizuoka (JP); Koji TAKINAMI, Kanagawa (JP); Yoichi NAKAGAWA, Tokyo (JP); Masataka IRIE, Kanagawa (JP)

(21) Appl. No.: 19/225,915

(22) Filed: Jun. 2, 2025

(30) Foreign Application Priority Data
Jun. 4, 2024 (JP) 2024-090848

(51) Int. Cl. G01S 13/75; G01S 7/02; G01S 13/931

(52) U.S. Cl. CPC G01S 13/75; G01S 7/024; G01S 13/931; G01S 2013/9329

(57) ABSTRACT

A radar apparatus in an aspect of the present disclosure includes: a radar module including a transmitting antenna that transmits a transmission signal; and a re-radiator including a re-radiating element that re-radiates the transmission signal.

### TECHNICAL FIELD

The present disclosure relates to a radar apparatus and a vehicle.

### BACKGROUND ART

In order to implement an imaging function (acquisition of an image) in a radar apparatus, further studies are being conducted to enhance resolution in the vertical and horizontal directions. In existing technology, it is known that, when the separation performance of an object is improved by narrowing a beam, high resolution is realized, and that, in order to narrow a beam, the antenna aperture may be increased. Here, as a method of increasing the antenna aperture, a method in which the number of antennas is increased, and a method in which the number of antennas is not increased but antennas are arranged by increasing the distance therebetween are known.

In a case where the number of antennas is increased, there is a problem with the module size and heat generation since the board size increases as the number of antennas increases and the number of ICs for controlling the antennas also increases.

In a case where antennas are arranged by increasing the distance therebetween, the board size increases. Further, since the distance between antennas is no longer a half wavelength (λ/2), there is a problem in that the detection performance deteriorates due to the occurrence of grating lobes (side lobes).

For example, Patent Literature (hereinafter referred to as “PTL”) 1 proposes, with respect to the radiation pattern of a radar apparatus, that a beam is narrowed using a lens formed with a metamaterial to control the radiation pattern thereof. Further, Non-Patent Literature (hereinafter referred to as “NPL”) 1 proposes a method for controlling the radiation pattern by forming a meta-lens that controls the transmission amplitude and transmission phase of a sheet using metamaterial technology, in order to suppress side lobes.

### CITATION LIST

### Patent Literature

PTL 1
Japanese Unexamined Patent Application Publication (Translation of PCT Application) No.
2010-526318
PTL 2
Japanese Patent Application Laid-Open No. 2023-011202
PTL 3
Japanese Patent Application Laid-Open No. 2020-153872
PTL 4
Japanese Patent Application Laid-Open No. 2020-060483
PTL 5
Japanese Patent Application Laid-Open No. 2020-060485

### Non-Patent Literature

NPL 1
Lin-Xiao Wu, Na Zhang; Kai Qu, Ke Chen, Tian Jiang, and Junming Zhao, “Transmissive Metasurface With Independent Amplitude/Phase Control and Its Application to Low-Side-Lobe Metalens Antenna” IEEE Transactions on Antennas and Propagation (Volume: 70, Issue: 8, August 2022)
NPL 2
Evangelos Vassos, William Whittow, and Alexandros Feresidis, “Design of a novel polarization converter based on artificial materials with metallic meta-atoms” The Loughborough Antennas & Propagation Conference (LAPC 2018)

### SUMMARY OF INVENTION

The present disclosure facilitates providing, with respect to a MIMO radar, a radar apparatus and a vehicle each capable of realizing high resolution by physically increasing the number of antennas and improving accuracy in detecting the position of a target object.

A radar apparatus in an aspect of the present disclosure includes: a radar module including a transmitting antenna that transmits a transmission signal; and a re-radiator including includes a re-radiating element that re-radiates the transmission signal.

A vehicle in an aspect of the present disclosure is a vehicle in which a radar apparatus is mounted. The radar apparatus includes: a radar module that includes a transmitting antenna that transmits a transmission signal; and a re-radiator that includes a re-radiating element that re-radiates the transmission signal.

According to an exemplary embodiment of the present disclosure, it is possible to improve accuracy in detecting the position of a target object by enhancing resolution.

### BRIEF DESCRIPTION OF DRAWINGS

FIG. 1 is a diagram provided for describing the concept of a radar apparatus;

FIG. 2 is an overall configuration diagram;

FIG. 3 is a diagram provided for describing the concept of the radar apparatus according to Embodiment 1;

FIG. 4 is a diagram provided for describing the concept of the radar apparatus according to Embodiment 1;

FIG. 5A is a diagram illustrating radiating directions in a case where directions in which signals are radiated are not controlled;

FIG. 5B is a diagram illustrating radiating directions in a case where directions in which signals are radiated are controlled;

FIG. 6 is a diagram provided for describing the concept of the radar apparatus according to Embodiment 6;

FIG. 7 is a diagram provided for describing the concept of the radar apparatus according to a variation of Embodiment 6;

FIG. 8A is a diagram provided for describing the concept of the radar apparatus according to Embodiment 7;

FIG. 8B is a diagram provided for describing the concept of the radar apparatus according to Embodiment 7;

FIG. 9A is a diagram provided for describing the concept of the radar apparatus according to Variation 1 of Embodiment 7;

FIG. 9B is a diagram provided for describing the concept of the radar apparatus according to Variation 1 of Embodiment 7;

FIG. 10A is a diagram provided for describing the concept of the radar apparatus according to Variation 2 of Embodiment 7;

FIG. 10B is a diagram provided for describing the concept of the radar apparatus according to Variation 2 of Embodiment 7;

FIG. 11A is a diagram provided for describing the concept of the radar apparatus according to Variation 3 of Embodiment 7;

FIG. 11B is a diagram provided for describing the concept of the radar apparatus according to Variation 3 of Embodiment 7;

FIG. 12 is a diagram provided for describing the concept of the radar apparatus according to Embodiment 8;

FIG. 13 is a diagram provided for describing times when a transmitting antenna element and re-radiating elements radiate a signal;

FIG. 14 is a diagram illustrating the configuration of radar receiver 119 according to Embodiment 8;

FIG. 15 is a diagram provided for describing an outline of separation in a beat frequency analyzer;

FIG. 16 is a diagram provided for describing the concept of the radar apparatus according to Variation 1 of Embodiment 8;

FIG. 17 is a diagram provided for describing times when a transmitting antenna element and re-radiating elements radiate a signal;

FIG. 18 is a diagram provided for describing the concept of the radar apparatus according to Variation 2 of Embodiment 8;

FIG. 19 is a diagram provided for describing the concept of the radar apparatus according to Embodiment 9;

FIG. 20A is a diagram illustrating vertical polarization;

FIG. 20B is a diagram illustrating horizontal polarization;

FIG. 20C is a diagram illustrating right-hand circular polarization;

FIG. 20D is a diagram illustrating left-hand circular polarization;

FIG. 21 is a diagram provided for describing an outline in a case where the radar apparatus according to Embodiment 10 is mounted on a vehicle;

FIG. 22 is a diagram illustrating a configuration example of a thin radar apparatus; and

FIG. 23 is a diagram illustrating a configuration example of a thin radar apparatus.

### DESCRIPTION OF EMBODIMENTS

Hereinafter, embodiments of the present disclosure will be described in detail with reference to the accompanying drawings as appropriate.

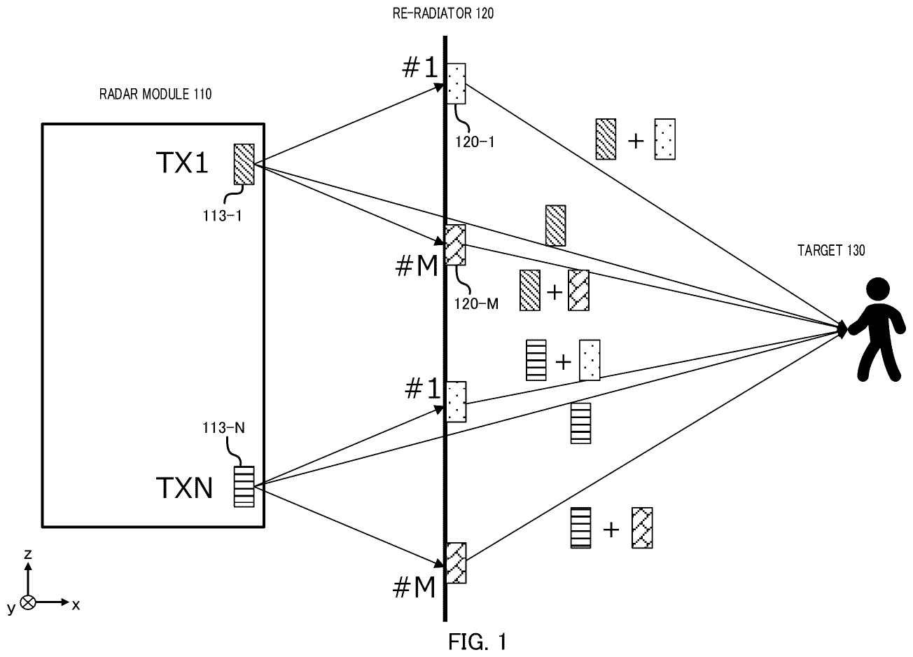

Radar module 110 illustrated in FIG. 1 includes N transmitting antenna elements 113-1 to 113-N arranged in the zy plane, and re-radiator 120 illustrated in FIG. 1 includes M re-radiating elements 120-1 to 120-M arranged in the zy plane for each transmitting antenna element of transmitting antenna elements 113-1 to 113-N. Radio waves (transmission signals) that have been radiated by respective transmitting antenna elements 113-1 to 113-N are re-radiated by respective re-radiating elements 120-1 to 120-M. For example, when radio waves that have been radiated by respective transmitting antenna elements 113-1 to 113-N of radar module 110 in the x-axis direction are re-radiated by re-radiator 120, at least one of phase, delay time, and polarization of the radio waves is converted by re-radiating elements #1 and #M. Radar module 110 can receive reflected waves, which are radio waves re-radiated by the respective re-radiating elements in the x-axis direction and reflected by target 130, and reflected waves, which are radio waves radiated by the transmitting antenna elements in the x-axis direction and reflected by target 130. Further, when a transparent film is used for re-radiator 120, radio waves transmitted through the transparent film without passing through M re-radiating elements 120-1 to 120-M of re-radiator 120 are reflected by target (target object) 130 and received by radar module 110. Since the respective radio waves re-radiated by and transmitted through re-radiator 120 differ in at least one of phase, delay time, and polarization, radar module 110 can separate received reflected waves into reflected waves of radio waves re-radiated by each re-radiating element or transmitted through transparent film. When N transmitting antenna elements 113-1 to 113-N of radar module 110 and M re-radiating elements 120-1 to 120-M of re-radiator 120 are used, it is possible to separate radio waves into N×(M+1) radio waves in consideration of the transmission through the transparent film. For example, when re-radiator 120 is used, it is possible to obtain the same effect as when the number of transmitting antennas in a Multi Input Multi Output (MIMO) radar is increased by a factor of (M+1) without applying any change to radar module 110, and it is possible to increase the number of virtual receiving antennas in the MIMO radar. The radar apparatus can enlarge the aperture length of the virtual receiving antennas in the MIMO radar, and can improve the angle measurement performance (angle measurement estimation accuracy and angle resolution for a plurality of target objects).

Re-radiator 120 re-radiates radio waves radiated by radar module 110, but does not re-radiate reflected signals received by radar module 110. For example, for reflected signals, re-radiator 120 is not involved in the reception by radar module 110 (is transparent). Re-radiating elements 120-1 to 120-M are installed at locations where re-radiating elements 120-1 to 120-M re-radiate radio waves radiated by radar module 110, but do not re-radiate reflected signals received by radar module 110.

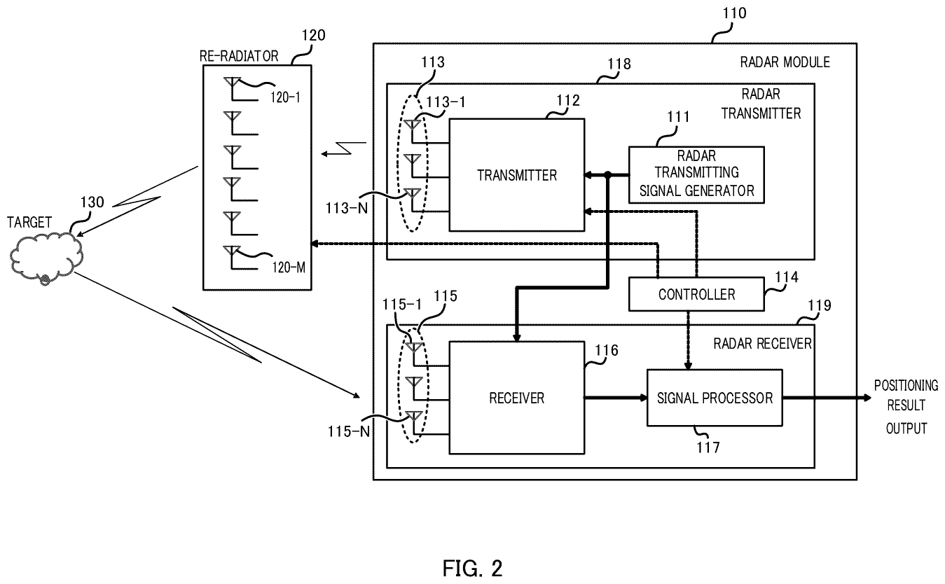

Radar module 110 illustrated in FIG. 2 includes radar transmission signal generator 111, transmitter 112, transmitting antenna 113, controller 114, receiving antenna 115, receiver 116, and signal processor 117. Radar transmission signal generator 111, transmitter 112 and transmitting antenna 113 form transmitter 118, and receiving antenna 115, receiver 116, and signal processor 117 form receiver 119. Controller 114 may be included in radar transmitter 118 or may be included in radar receiver 119.

A radar transmission signal is code-division multiplexed (CDM: Code Division Multiplexing) or time-division multiplexed (TDM: Time Division Multiplexing) and transmitted by radar module 110. The transmission signal that has been transmitted by radar module 110 is re-radiated by re-radiator 120, reflected by target 130, and received by radar module 110. PTL 2 describes a configuration in which code division multiplexing is performed and transmission from a transmitting antenna is performed, and PTL 3 describes a configuration in which time division multiplexing is performed and transmission from a transmitting antenna is performed. The configuration in which code division multiplexing is performed and transmission from a transmitting antenna is performed and the configuration in which time division multiplexing is performed and transmission from a transmitting antenna is performed are well known in the art as described above, and hereinafter, outlines of configurations of radar transmission signal generator 111, transmitter 112, transmitting antenna 113, controller 114, receiving antenna 115, receiver 116, and signal processor 117 will be described.

Radar transmission signal generator 111 generates a transmission signal. Radar transmission signal generator 111 includes, for example, a modulated signal generator and a voltage controlled oscillator (VCO). The modulated signal generator generates a saw-tooth-shaped modulated signal (for example, a modulated signal for VCO control) for each radar transmission period Tr. The VCO generates, based on the modulated signal outputted from the modulated signal generator, a frequency-modulated signal (hereinafter referred to as a frequency chirp signal or a chirp signal, for example), and outputs the generated frequency chirp signal or chirp signal to transmitter 112. Radar transmission signal generator 111 may generate a transmission signal for each radar transmission period Tr by using codes of different code sequences.

Transmitter 112 performs control for code-division multiplexing or time-division multiplexing a transmission signal.

Transmitting antenna 113 includes N transmitting antenna elements 113-1 to 113-N. Transmitting antenna 113 radiates a signal, which has been received from transmitter 112, into space. The configurations of respective transmitting antenna elements 113-1 to 113-N may be the same, or may include a different configuration(s).

Controller 114 controls transmitter 112, signal processor 117, and re-radiator 120.

Receiving antenna 115 includes L receiving antenna elements 115-1 to 115-L at locations different from those of transmitting antenna elements 113-1 to 113-N. Receiving antenna 115 receives a reflected signal reflected by a target (target object). Reflected signals received by the respective receiving antenna elements are outputted to receiver 116.

Receiver 116 includes, for example, an amplifier and a detector. Receiver 116 demodulates a reflected signal received by receiving antenna 115. Receiver 116 outputs a demodulated reflected signal to signal processor 117.

Signal processor 117 includes an AD converter, an output switch, a Doppler analyzer, and the like. Signal processor 117 performs positioning of target 130 based on a signal inputted from receiver 116 and outputs the result thereof.

Re-radiator 120 includes a plurality of re-radiating elements 120-1 to 120-M. The configurations of the respective re-radiating elements are the same, and radio waves re-radiated by the respective re-radiating elements are different in at least one of phase, delay time, and polarization.

### Embodiment 1

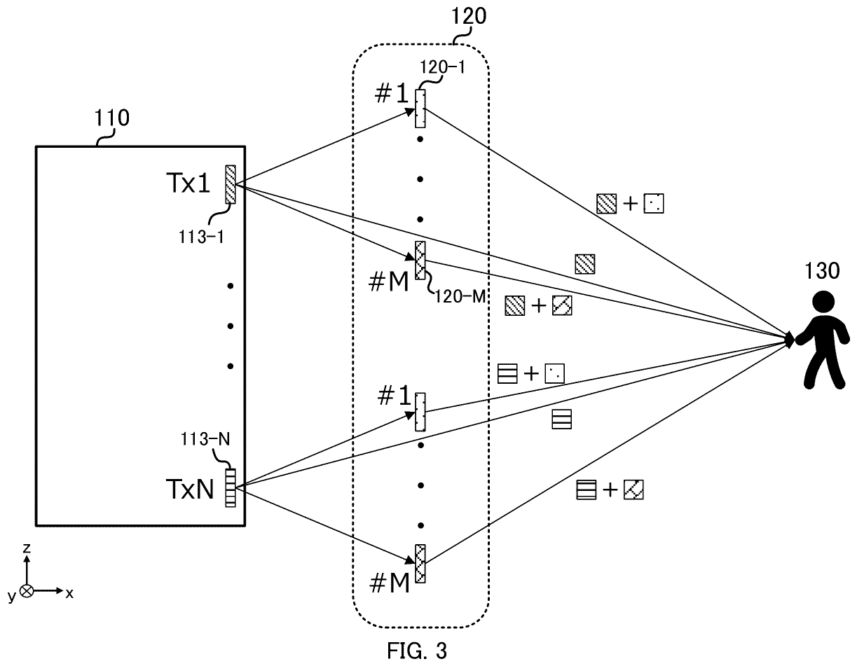

Radar module 110 illustrated in FIG. 3 includes N transmitting antenna elements. Re-radiator 120 is located physically remote from radar module 110 and includes M re-radiating elements. Transmission signals that have been radiated by the respective transmitting antenna elements are re-radiated by the respective re-radiating elements of re-radiator 120 or are transmitted through re-radiator 120 without being re-radiated by re-radiator 120 and reach target 130. For example, transmission signals that have been radiated by the respective transmitting antenna elements reach, as M+1 transmission signals, target 130. For example, N×(M+1) transmission signals reach target 130 by radar module 110 including N transmitting antenna elements and re-radiator 120 including M re-radiating elements. Accordingly, it can be said that N×(M+1) transmitting antennas are formed as a MIMO radar. Here, N and M are both integers equal to or greater than one.

By configuring the material of at least a portion of re-radiator 120 to have a high radio wave transmissibility, such as a transparent film, transmission signals radiated by respective transmitting antenna elements 113-1 to 113-N can reach target 130 as they are.

Note that, re-radiator 120 may be attached to a radome that protects radar module 110 (or transmitting antenna 113). For example, it may also be configured such that re-radiator 120 is attached to the inside (a surface facing the antennas) of a radome. With such a configuration, the radome allows protection of not only radar module 110 (or transmitting antenna 113) but also re-radiator 120 (which is applicable to the following embodiments in the same manner, and the same effect can be obtained). For example, in a case where at least a portion of re-radiator 120 is formed of a material having a high radio wave transmissibility, such as a transparent film, it may be configured such that a transparent film is attached to the inside (a surface facing the antennas) of a radome.

### Embodiment 2

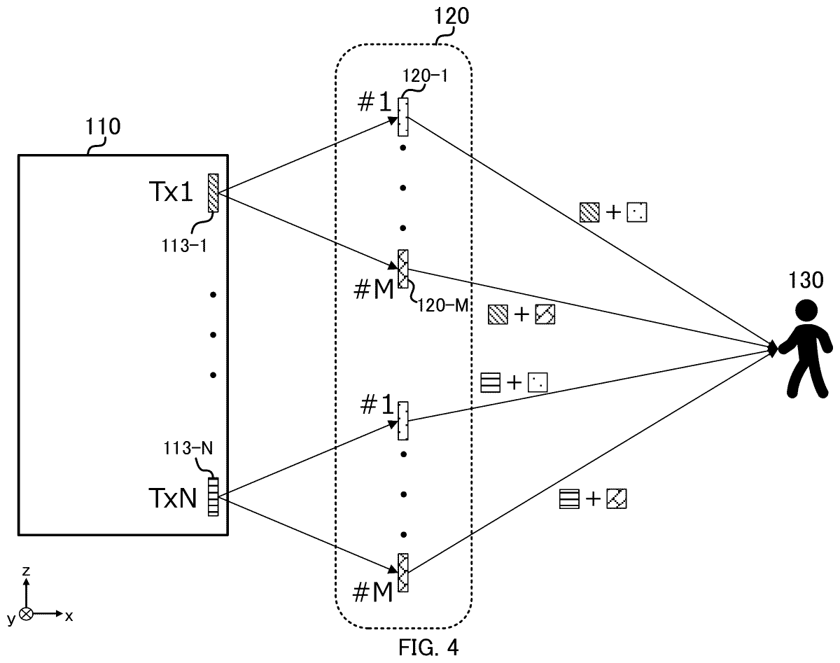

Radar module 110 illustrated in FIG. 4 includes N transmitting antenna elements. Re-radiator 120 is located physically remote from radar module 110 and includes M re-radiating elements. Transmission signals that have been radiated by the respective transmitting antenna elements are re-radiated by the respective re-radiating elements of re-radiator 120 and reach target 130. For example, transmission signals that have been radiated by the respective transmitting antenna elements reach, as M transmission signals, target 130. For example, N×M transmission signals reach target 130 by radar module 110 including N transmitting antenna elements and re-radiator 120 including M re-radiating elements. Accordingly, it can be said that N×M transmitting antennas are formed as a MIMO radar. Here, N is an integer equal to or greater than one, and M is an integer equal to or greater than two.

It can be understood that in Embodiment 2 described above, a case where one of the re-radiating elements is a transparent re-radiating element, for example, a re-radiating element which is not involved in re-radiation at all is Embodiment 1. Accordingly, in the following description and the recitation of the claims, the re-radiating elements include a transparent re-radiating element. The transparent re-radiating element is a re-radiating element which is not involved in re-radiation and through which radio waves that have been radiated by a transmitting antenna are transmitted as they are, and which includes a state in which there is no re-radiating element and radio waves are transmitted through re-radiator 120.

According to Embodiment 2, on the other hand, even when a re-radiating element(s) is/are disposed on a member (for example, a board) formed of a material which blocks radio waves (through which radio waves are not transmitted), it is possible to increase the number of transmitting antennas in a MIMO radar. For example, even when a board is formed of a material that blocks radio waves, a re-radiating element(s) may receive a transmission signal, which has been radiated by a transmitting antenna element, on one surface of the board, and may re-radiate the transmission signal from the other surface of the board.

### Embodiment 3

For the re-radiating element in Embodiments 1 and 2, it is possible to use a metamaterial structure. By configuring the re-radiating element to have a metamaterial structure, it is possible to control the phase and on/off of the re-radiating element or to perform polarization conversion. For example, NPL 1 proposes a phase control method using a metamaterial, and NPL 2 proposes a polarization conversion technique using a metamaterial.

### Embodiment 4

In Embodiments 1 and 3, the re-radiating element may be formed on a transparent film. By configuring the re-radiating element on a transparent film, it is possible to place the re-radiating element without impairing the appearance since the transparent film on which the re-radiating element is formed can be affixed to the windshield.

### Embodiment 5

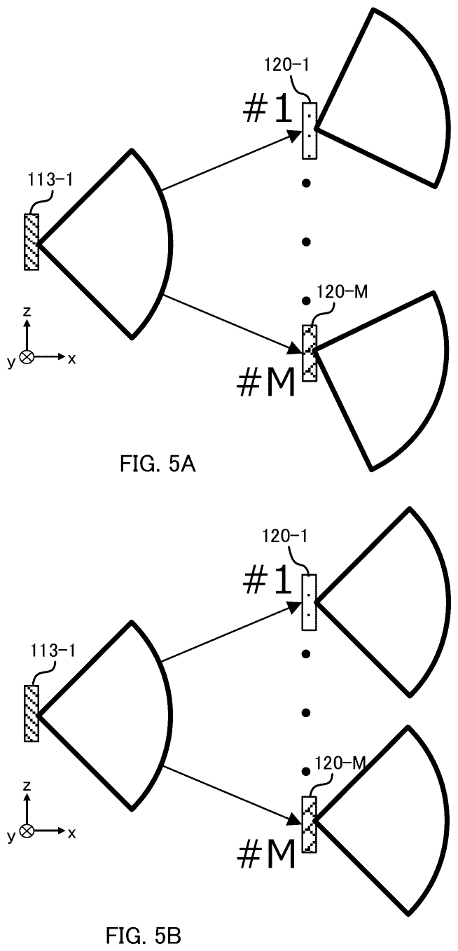

FIG. 5A illustrates radiating directions in a case where directions in which signals are radiated by re-radiating elements are not controlled, and FIG. 5B illustrates radiating directions in a case where directions in which signals are radiated by re-radiating elements are controlled.

In a case where a direction in which radiation is performed by a re-radiating element is not controlled, the re-radiating element may perform re-radiation with directivity in which the direction in which reception from a transmitting antenna element has been performed is the maximum radiating direction, as illustrated in FIG. 5A. For example, in FIG. 5A, the directivity of re-radiating element 120-1 (#1) is inclined in the positive direction of the z-axis, the directivity of re-radiating element 120-M (#M) is inclined in the negative direction of the z-axis. In that case, since the maximum radiating direction for re-radiation varies depending on the position of a re-radiating element, radio waves that have been re-radiated by the re-radiating element are less likely to reach target 130 depending on the position of target 130, and, performance as a MIMO radar may deteriorate and may become difficult to detect target 130. In FIG. 5B, the inclinations in the Z-axis direction of the directivity of re-radiating element 120-1 (#1) and the directivity of re-radiating element 120-M (#M) are controlled, and each re-radiating element 120 can perform re-radiation along the x-axis.

In Embodiments 1 to 4, in a case where a direction in which radiation is performed by a re-radiating element is controlled, the re-radiating element may radiate radio waves with the same directivity whose maximum radiating direction is the same direction as the maximum radiating direction of the directivity with which a transmitting antenna element performs radiation. When directivity is controlled using a metamaterial structure for a re-radiating element, the re-radiating element can perform re-radiation with the same directivity whose maximum radiating direction is the same direction as the maximum radiating direction of the directivity with which a transmitting antenna element performs radiation. Further, when a re-radiating element has a metamaterial structure, it is possible to individually adjust the directivity of the re-radiating element. Since the maximum radiating direction of the directivity with which a transmitting antenna element performs radiation and the maximum radiating direction of the directivity with which each re-radiating element perform radiation are the same (for example, the same directivity), radio waves that have been re-radiated by every re-radiating element can be reflected by target 130 and received by radar module 110, with the result that the aperture length of the virtual receiving antennas of a MIMO radar increases, and the angle measurement performance can be improved, and target 130 can be surely detected. Note that, although a case where the maximum radiating direction of the directivity with which a transmitting antenna element performs radiation and the maximum radiating direction of the directivity with which each re-radiating element perform radiation are the same has been described above, the present disclosure is not limited thereto, and for example, when each re-radiating element is formed of an element having a metamaterial structure, it is also possible to broaden the field of view of a radar by controlling the maximum radiating direction of the directivity with which each re-radiating element performs radiation to cause different radiating directions.

### Embodiment 6

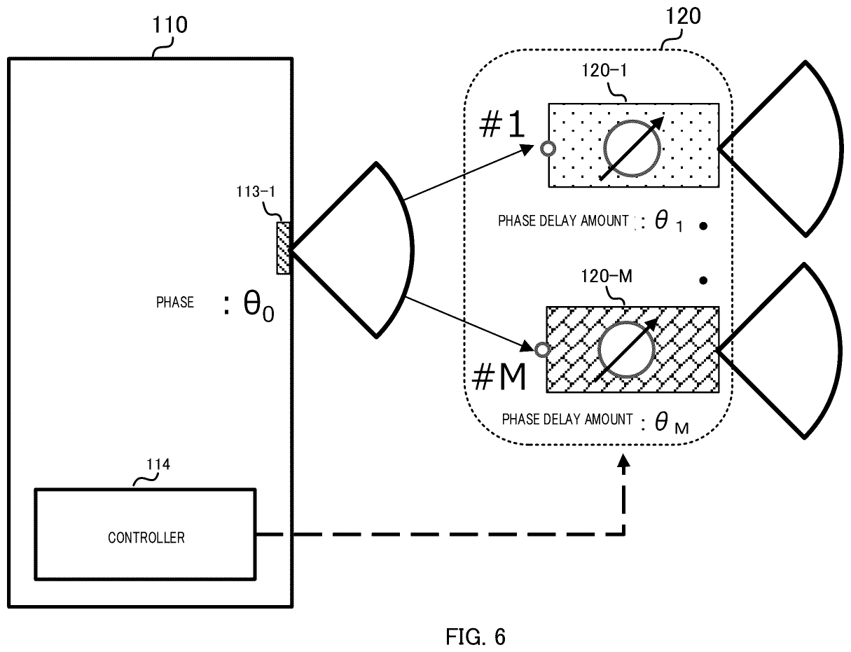

FIG. 6 illustrates the radar apparatus in which controller 114 is added to radar module 110 described in Embodiments 1 to 5 and controller 114 controls phase shifters included in re-radiating elements 120-1 to 120-M. Controller 114 illustrated in FIG. 6 controls the phases at which the respective re-radiating elements perform re-radiation and causes the phases of signals, which are re-radiated by the re-radiating elements, to be orthogonal to each other. The re-radiating elements include, for example, phase shifters. Controller 114 controls the phase shifters such that a desired phase rotation is given for each re-radiating element. Controller 114 performs control such that the phase is as desired at the surface of a re-radiating element. Controller 114 controls, in consideration of the phase difference due to the distance difference between the transmitting antenna element and each re-radiating element, the phase at which each re-radiating element performs re-radiation. By performing control such that the phases of signals that are re-radiated by the respective re-radiating elements are orthogonal to each other, it is possible to separate reflected signals that are signals radiated by the respective re-radiating elements and reflected by target 130.

When each re-radiating element is configured to be an element having a metamaterial structure, controller 114 can control the phase. For the phase control using a metamaterial, various structures have been proposed, which include, for example, a proposal as in NPL 1.

For radar module 110, both code division multiplexing and time division multiplexing can be used. Note that, radar module 110 makes it possible to obtain the same effect even when Doppler division multiplexing is used.

### (Variation)

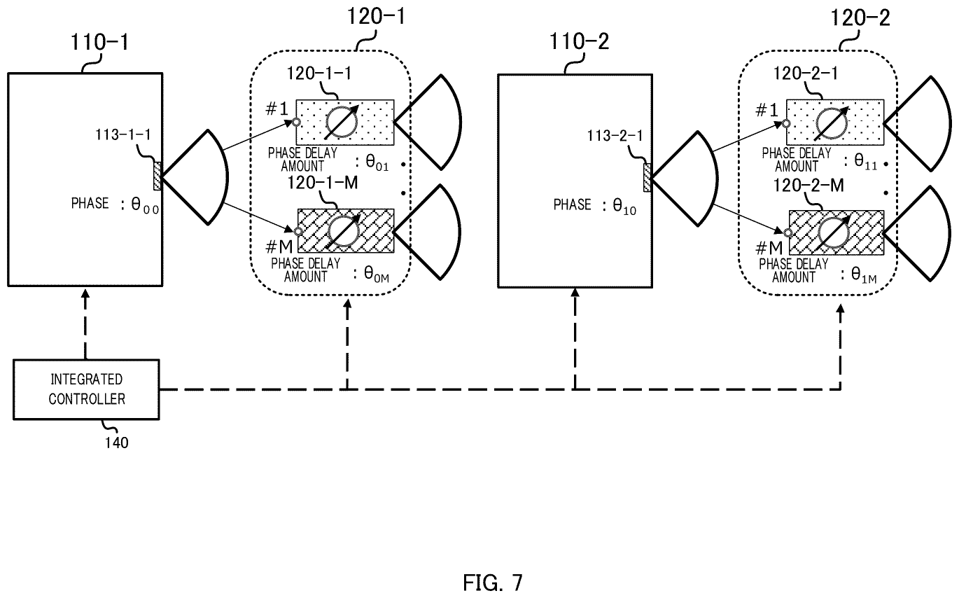

As illustrated in FIG. 7, in a case where a plurality of radar modules 110-1 and 110-2 is used, integrated controller 140 is provided, and integrated controller 140 controls controllers 114 of respective radar modules 110. Radar module 110-1 includes transmitting antenna element 113-1, and re-radiator 120-1 includes re-radiating elements 120-1-1 to 120-1-M corresponding thereto. The radar module may include a plurality of transmitting antenna elements. Respective radar modules 110-1 and 110-2 may have the same configuration, the number of transmitting antenna elements and the number of receiving antenna elements, where the transmitting antenna elements and the receiving antenna elements are included in each radar module, may be different between radar modules 110-1 and 110-2, or the number of re-radiating elements included in re-radiator 120-1 and the number of re-radiating elements included in re-radiator 120-2 may be different. Integrated controller 140 performs phase control of respective transmitting antenna elements 113-1-1 and 113-2-1 of respective radar modules 110-1 and 110-2 as well as re-radiating elements 120-1-1 to 120-1-M and 120-2-1 to 120-2-M. The radar apparatus is provided with re-radiators 120 whose number corresponds to the number of radar modules 110. Although one re-radiator 120 is provided correspondingly to one radar module 110 in FIG. 7, one re-radiator 120 may also be provided correspondingly to a plurality of radar modules 110. Further, controller 114 of one radar module 110 (for example, controller 114 of radar module 110-1) may also function as integrated controller 140.

### Embodiment 7

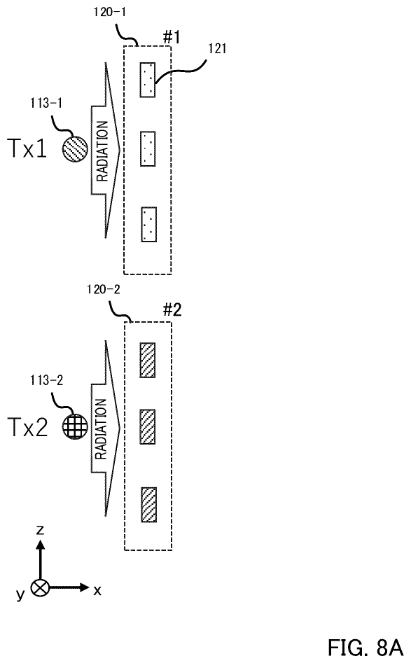

As illustrated in FIGS. 8A and 8B, re-radiating element 120-1 may be a reconfigurable intelligent surface (RIS) formed by periodically arranging a plurality of elements 121. In the configuration illustrated in FIG. 8A, a transmission signal that has been radiated by transmitting antenna element 113-1 is re-radiated by re-radiating element 120-1, and a transmission signal that has been radiated by transmitting antenna element 113-2 is re-radiated by re-radiating element 120-2. In FIG. 8B, each of re-radiating elements 120-1 and 120-2 are formed of nine elements arranged in 3×3, for example. Controller 114 turns on different elements depending on the time. For example, controller 114 turns on the elements in the left and middle columns and turns off the elements in the right column at time T=1. For example, controller 114 turns on the elements in the middle and right columns and turns off the elements in the left column at time T=2. Controller 114 alternately repeats the RIS pattern (the state of the respective elements) of time T=1 and the RIS pattern of time T=2. Each re-radiator realizes a specific directivity by six elements which are on. Since the re-radiating element is formed of such a plurality of elements, and can form a directional beam, an effect of increasing a directional gain in a predetermined angular range is obtained, and an effect of enlarging a target object detection distance range in the radar apparatus is obtained.

When elements to be turned on change among a plurality of elements, the phase center of the RIS pattern formed of the elements that are on changes. Since a change in the phase center in time division means that the positions of respective re-radiating elements change in time division, it can be said that the same effect as in an operation in which transmitting antennas are switched in time division is obtained, and that the number of transmitting antennas in a MIMO radar is increased. Hereinafter, re-radiating elements obtained by partially operating a plurality of elements while allowing the plurality of elements to overlap in time division will also be referred to as virtual re-radiating elements. VEs which are switched in time division and correspond to respective re-radiating elements are formed of respective RIS patterns. In FIGS. 8A and 8B, the VE corresponding to the re-radiating elements at time T=1 is VE #1, and the VE corresponding to the re-radiating elements at time T=2 is VE #2. The positions of the phase centers in VE #1 and VE #2 are different.

The element arrangement and elements to be turned on are not limited to the example in FIGS. 8A and 8B. When a phase center changes in time division, controller 114 may turn on arbitrary elements with respect to an arbitrary element arrangement. The elements to be turned on may overlap in respective RIS patterns.

Note that, directional beams by virtual re-radiating elements VE #1 and VE #2 when virtual re-radiating elements VE #1 and VE #2 are switched in time division may be configured to be directional beams that have the same directivity in time division, or may be configured to be directional beams that have different directivities. Alternatively, beam control that adaptively varies a directional beam may be used.

### (Variation 1)

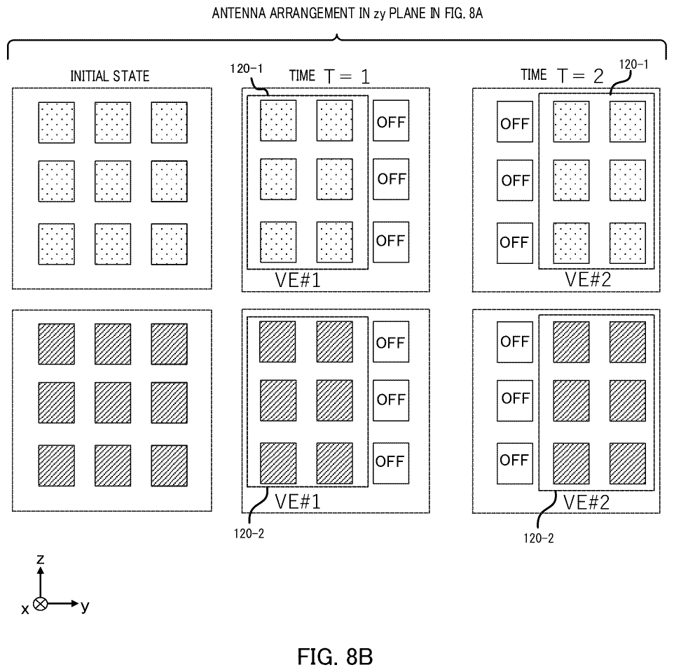

In Variation 1 illustrated in FIGS. 9A and 9B, on the one hand, a plurality of transmitting antenna elements radiates code-division multiplexed transmission signals, on the other hand, re-radiating elements switch RIS patterns in time division. For example, the same RIS pattern is used between the code lengths of codes at the time of code-division multiplexing transmission with a plurality of transmitting antenna elements. The plurality of transmitting antenna elements may radiate Doppler-division multiplexed (DDM: Doppler Division Multiplexing) transmission signals rather than code-division multiplexed transmission signals.

A plurality of transmitting antenna elements 113-1 and 113-2 illustrated in FIG. 9A radiates, for example, transmission signals that have been code-division multiplexed by using a code of a code length of two. For example, the code used in transmitting antenna element Tx1 is code [1, 1], and transmitting antenna element Tx1 repeatedly transmits, for example, a chirp signal serving as a reference (for example, transmits 1, 1, 1, 1 from times 1 to 4). The code used in transmitting antenna element Tx2 is, on the other hand, code [1, −1], and transmitting antenna element Tx2 alternately transmits a chirp signal (corresponding to the code element 1) having the same phase with respect to the chirp signal serving as the reference and a chirp signal with phase difference π (corresponding to the code element −1) with respect to the chirp signal serving as the reference (for example, transmits 1, −1, 1, −1 from times 1 to 4).

For this reason, at times T=1 and 3, transmitting antenna element Tx1 transmits a chirp signal of phase 0 (reference phase) and transmitting antenna element Tx2 transmits a chirp signal of phase 0 (reference phase), whereas at times T=2 and 4, transmitting antenna element Tx1 transmits a chirp signal of phase 0 (reference phase) and transmitting antenna element Tx2 transmits a chirp signal of phase π (phase difference π with respect to the reference phase).

Further, as illustrated in FIG. 9B, for example, controller 114 turns on the elements in the left and middle columns and turns off the elements in the right column at times T=1 and 2. For example, controller 114 turns on the elements in the middle and right columns and turns off the elements in the left column at times T=3 and 4. Controller 114 alternately repeats the state at times T=1 and 2 and the state at times T=3 and 4. Controller 114 switches RIS patterns with a period corresponding to the code length of a code used in the transmitting antenna elements (for example, two periods in FIG. 9A), thereby performing a multiplex virtual antenna. In FIG. 9B, times T=1 and 2 are VE #1, times T=3 and 4 are VE #2, and the positions of the phase centers in VE #1 and VE #2 are different.

The present embodiment makes it possible to obtain the same effect as increasing the number of transmitting antennas in a MIMO radar by using common re-radiating elements with respect to transmitting antenna elements for which code division multiplexing (or Doppler division multiplexing) is performed, and, it is possible to increase the number of virtual receiving antennas in a MIMO radar and to enlarge the aperture length therein while reducing the number of re-radiating elements, and it is possible to improve the angle measurement performance (angle measurement estimation accuracy and angle resolution for a plurality of target objects). Further, by the effect of reducing the number of re-radiating elements, it is possible to reduce the installation area of re-radiating elements, and it is also possible to obtain the effect of reducing the size of the radar apparatus.

Further, the present embodiment makes it possible to increase the number of virtual receiving antennas in a MIMO radar in proportion to the number of transmitting antenna elements for which code division multiplexing is performed and the number of RIS patterns of re-radiating elements for which time division multiplexing is performed.

Note that, directional beams by virtual re-radiating elements VE #1 and VE #2 when virtual re-radiating elements VE #1 and VE #2 are switched in time division may be configured to be directional beams that have the same directivity in time division, or may be configured to be directional beams that have different directivities. Alternatively, beam control that adaptively varies a directional beam may be used.

### (Variation 2)

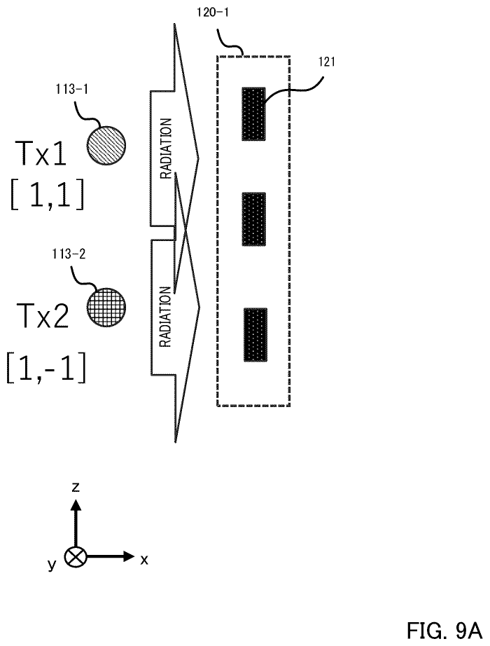

In Variation 1, code division multiplexing has been performed for transmitting antenna elements, whereas in Variation 2 illustrated in FIGS. 10A and 10B, code division multiplexing is performed for re-radiating elements. In Variation 2, the re-radiating element applies a beam forming phase of the re-radiating element as well as a phase for performing code division multiplexing, and further switches RIS patterns in time division. In Variation 2, the transmitting antenna element does not multiplex a signal. Note that, the re-radiating element may perform Doppler division multiplexing by applying a phase rotation, which results in Doppler division multiplexing, instead of code division multiplexing, whereby the same effect is obtained.

A transmission signal (for example, a chirp signal) that has been radiated by transmitting antenna element 113-1 is re-radiated by re-radiating elements 120-1 and 120-2. For example, the code used in transmitting antenna element Tx1 is code [1, 1], and transmitting antenna element Tx1 repeatedly transmits, for example, a chirp signal serving as a reference. For example, a phase rotation for each transmission period of the chirp signal (for example, times T=1 and 2) is not applied to the transmission signal that has been radiated by transmitting antenna element 113-1.

First, the application of a beam forming phase of a re-radiating element will be described. Two re-radiating elements 120-1 and 120-2 are formed of, for example, 15 elements arranged in 3×5. The RIS pattern of each re-radiating element changes in time division at the period of each time T by the control of controller 114. For example, controller 114 turns off the elements in the rightmost column at times T=1 and 2, and configures, for the elements in the remaining four columns, virtual re-radiating elements VE #1 and VE #2 in the two columns on the left side and the two columns on the right side, respectively. Virtual re-radiating elements VE #1 in the two columns on the left side are virtual re-radiating elements corresponding to re-radiating element 120-1, and virtual re-radiating elements VE #2 in the two columns on the right side are virtual re-radiating elements corresponding to re-radiating element 120-2. Controller 114 turns off the elements in the leftmost column at times T=3 and 4, and configures, for the elements in the remaining four columns, virtual re-radiating elements VE #3 and VE #4 in the two columns on the left side and the two columns on the right side, respectively. Virtual re-radiating elements VE #3 in the two columns on the left side are virtual re-radiating elements corresponding to re-radiating element 120-1, and virtual re-radiating elements VE #4 in the two columns on the right side are virtual re-radiating elements corresponding to re-radiating element 120-2. The positions of the phase centers in VE #1 to VE #4 are different from each other.

Further, virtual re-radiating elements VE #1 (or VE #2) with the respective RIS patterns of the re-radiating elements at times T=1 and 2 are formed of, for example, six elements arranged in 3×2, and beam forming phases Φ 1 to Φ 6 (or Φ 7 to Φ 12) using the above plurality of elements are applied and a beam is formed in a predetermined direction. Beams formed by virtual re-radiating elements VE #1 and VE #2 may form directional beams that become substantially the same, or may form directional beams having different main beam directions. Further, in the same manner, virtual re-radiating elements VE #3 (or VE #4) with the respective RIS patterns of the re-radiating elements at times T=3 and 4 are formed of, for example, six elements arranged in 3×2, and beam forming phases Φ1 to 6 (or Φ7 to Φ12) using the above plurality of elements are applied and a beam is formed in a predetermined direction. Further, virtual re-radiating elements VE #1, VE #2, VE #3, and VE #4 may form directional beams that become substantially the same, or may form directional beams having different main beam directions. Since the directional gain can be increased when such a directional beam is formed using such a plurality of elements, it is possible to increase the signal to noise ratio (SNR) of a received signal of a reflected wave from a target object in the directional beam direction.

Next, the application of a phase for performing code division multiplexing, which is performed together with the application of a beam forming phase of a re-radiating element, will be described. For example, virtual re-radiating elements VE #1 (or VE #2) with the RIS patterns of the re-radiating elements at times T=1 and 2 make it possible to re-radiate a signal as a code-division multiplexed (or Doppler-division multiplexed) signal by further applying, in addition to beam forming phases Φ1 to Φ6 (or Φ7 to Φ12) using a plurality of elements, phase rotations with different codes.

For example, the code used in virtual re-radiating elements VE #1 formed of the elements in the two columns on the left side is code [1, 1] at times T=1 and 2. In this case, when phase rotations are superimposed on the beam forming phases using a plurality of elements, the phase rotations are applied to [Φ1, Φ1] to [Φ6, Φ6] with respect to a plurality of elements, respectively, whose number is six. The virtual re-radiating elements generate, with a predetermined directional beam pattern, a beam of a transmission signal (for example, a chirp signal) obtained by configuring the phase for a transmission signal (for example, a chirp signal), which is incident on the virtual re-radiating elements from transmitting antenna element 113-1, to be phase 0 (no application of phase rotation or the application of a predetermined phase rotation serving as a reference phase), and re-radiates the generated beam.

Further, the code used in virtual re-radiating elements VE #2 formed of the elements in the two columns on the right side is code [1,−1] at times T=1 and 2. In this case, when phase rotations are superimposed on the beam forming phases using a plurality of elements, the phase rotations are applied to [Φ7,−Φ7] to [Φ12,−[12] with respect to a plurality of elements, respectively, whose number is six. The virtual re-radiating elements generate, with a predetermined directional beam pattern, a beam of a transmission signal (for example, a chirp signal) obtained by configuring the phase for a transmission signal (for example, a chirp signal), which is incident on the virtual re-radiating elements from transmitting antenna element 113-1, to be phase 0 (no application of phase rotation or the application of a predetermined phase rotation serving as a reference phase) or phase π (the application of a phase rotation with phase difference π with respect to the phase at “phase 0”), and re-radiates the generated beam.

Further, in the same manner, virtual re-radiating elements VE #3 (or VE #4) with the respective RIS patterns of the re-radiating elements at times T=3 and 4 make it possible to re-radiate a signal as a code-division multiplexed (or Doppler-division multiplexed) signal by further applying, in addition to beam forming phases Φ 1 to Φ 6 (or Φ 7 to Φ 12) using a plurality of elements, phase rotations with different codes.

Controller 114 alternately repeats the state of times T=1 and 2 and the state of times T=3 and 4. Such code-division multiplexed and time-division multiplexed signals are signals orthogonal to each other, and the respective reflected waves reflected by a target can be separated and received by the radar receiver. For this reason, the re-radiating elements re-radiate a beam which is formed based on the respective RIS patterns of the virtual re-radiating elements and on which code division multiplexing has been performed (in the case of FIG. 10B, a re-radiating signal with two RIS patterns, and the code multiplexing number is two). In addition, RIS patterns are time-divided with periods according to the code length (two transmission periods in the case of FIG. 10A) (in the case of FIG. 10B, two RIS patterns are switched in time division every two transmission periods, and, the time multiplexing number is two). Such a control operation, in which code division multiplexing and time division multiplexing are mixed, of the controller for re-radiating elements makes it possible to obtain the same effect as increasing the number of transmitting antennas in a radar by a factor of (the code multiplexing number×the time multiplexing number), and to increase the number of virtual receiving antennas in a MIMO radar. It is possible to enlarge the aperture length of the virtual receiving antennas in the MIMO radar, and it is possible to improve the angle measurement performance (angle measurement estimation accuracy and angle resolution for a plurality of target objects).

When nine elements are associated with each re-radiating element as illustrated in FIGS. 8A, 8B, 9A and 9B, two re-radiating elements 120-1 and 120-2 are formed of 18 elements, but the number of elements can be reduced when two re-radiating elements 120-1 and 120-2 are configured by using 15 elements and combining code division multiplexing and time division multiplexing. It may also be configured such that a plurality of elements is associated with three or more re-radiating elements. For example, 3×(2K+1) elements may be associated with K re-radiating elements. Since each re-radiating element performs the same operation even in Embodiment 7 and Variation 1 of Embodiment 7, it is possible to configure N elements with respect to a plurality of re-radiating elements.

Note that, directional beams by virtual re-radiating elements VE #1 to VE #4 when virtual re-radiating elements VE #1 to VE #4 are switched in time division may be configured to be directional beams that have the same directivity in time division, or may be configured to be directional beams that have different directivities. Alternatively, beam control that adaptively varies a directional beam may be used.

### (Variation 3)

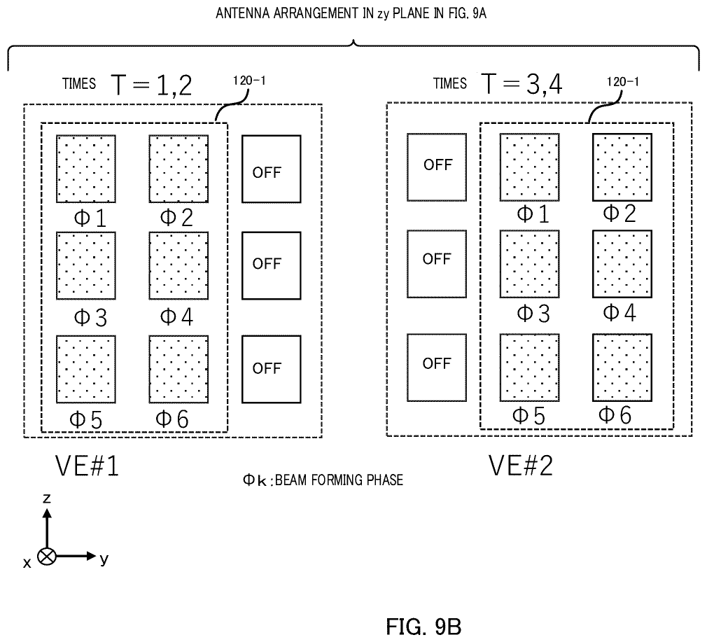

In Variation 2, an example in which the number of transmitting antennas is one and any transmitting antenna element does not perform multiplexing transmission, whereas Variation 3 illustrated in FIGS. 11A and 11B is a variation to which re-radiation, by a re-radiating element, of code-division multiplexed transmission signals which have been radiated by a plurality of transmitting antenna elements is added. In Variation 3, re-radiating elements apply beam forming phases of the re-radiating elements as well as phases for performing code division multiplexing to code-division multiplexed transmission signals from a plurality of transmitting antenna elements, and switches RIS patterns in time division. Note that, the re-radiating element may perform Doppler division multiplexing by applying a phase rotation, which results in Doppler division multiplexing, instead of code division multiplexing, whereby the same effect is obtained. Further, the transmitting antenna element may perform Doppler division multiplexing by applying a phase rotation, which results in Doppler division multiplexing, instead of code division multiplexing, whereby the same effect is obtained.

A plurality of transmitting antenna elements radiates code-division multiplexed signals. For example, the code used in transmitting antenna element Tx1 is code [1, 1, 1, 1], and transmitting antenna element Tx1 repeatedly transmits a chirp signal serving as a reference. The code used in transmitting antenna element Tx2 is, on the other hand, code [1, 1, −1, −1], and transmitting antenna element Tx2 repeatedly transmits chirp signals of phases 0, 0, π, and π in this order. Here, phase 0 is for a chirp signal (corresponding to the code element 1) having the same phase with respect to the chirp signal serving as the reference, and a chirp signal with phase difference π (corresponding to the code element −1) with respect to the chirp signal serving as the reference is transmitted at phase π.

For example, at times T=1 and 2, transmitting antenna element Tx1 transmits a chirp signal of phase 0 and transmitting antenna element Tx2 transmits a chirp signal of phase 0, whereas at time T=3 and 4, transmitting antenna element Tx1 transmits a chirp signal of phase 0 and transmitting antenna element Tx2 transmits a chirp signal of phase x. For this reason, an orthogonal code having a code length of four from two transmitting antenna elements Tx1 and Tx2 is used, code division multiplexing (with the code multiplexing number of two) is performed, and transmission is performed.

The transmission signals (for example, chirp signals) that have been radiated by transmitting antenna elements 113-1 and 113-2 are re-radiated by re-radiating elements 120-1 and 120-2.

Two re-radiating elements 120-1 and 120-2 are formed of, for example, 15 elements arranged in 3×5. The RIS patterns of the respective re-radiating elements are time-divided. For example, controller 114 turns off the elements in the rightmost column at times T=1 to 4, and configures, for the elements in the remaining four columns, virtual re-radiating elements VE #1 and VE #2 in the two columns on the left side and the two columns on the right side, respectively. Controller 114 turns off the elements in the leftmost column at times T=5 to 8, and configures, for the elements in the remaining four columns, virtual re-radiating elements VE #3 and VE #4 in the two columns on the left side and the two columns on the right side, respectively. The positions of the phase centers in VE #1 to VE #4 are different from each other.

Further, virtual re-radiating elements VE #1 (or VE #2) with the respective RIS patterns of the re-radiating elements at times T=1 to 4 are formed of, for example, six elements arranged in 3×2, and beam forming phases Φ 1 to Φ 6 (or Φ 7 to Φ 12) using the above plurality of elements are applied and a beam is formed in a predetermined direction. Beams formed by virtual re-radiating elements VE #1 and VE #2 may form directional beams that become substantially the same, or may form directional beams having different main beam directions. Further, in the same manner, virtual re-radiating elements VE #3 (or VE #4) with the respective RIS patterns of the re-radiating elements at times T=5 to 8 are formed of, for example, six elements arranged in 3×2, and beam forming phases Φ 1 to Φ 6 (or Φ 7 to Φ 12) using the above plurality of elements are applied and a beam is formed in a predetermined direction. Further, virtual re-radiating elements VE #1, VE #2, VE #3, and VE #4 may form directional beams that become substantially the same, or may form directional beams having different main beam directions. Since the directional gain can be increased when such a directional beam is formed using such a plurality of elements, it is possible to increase the signal to noise ratio (SNR) of a received signal of a reflected wave from a target object in the directional beam direction.

Further, virtual re-radiating elements VE #1 (or VE #2) with the RIS patterns of the re-radiating elements at times T=1 and 2 (or times T=3 and 4) make it possible to re-radiate a signal as a code-division multiplexed (or Doppler-division multiplexed) signal by further applying, in addition to beam forming phases Φ 1 to Φ 6 (or Φ 7 to Φ 12) using a plurality of elements, phase rotations with different codes.

For example, the code used in virtual re-radiating elements VE #1 formed of the elements in the two columns on the left side is code [1, 1] at times T=1 and 2 (or times T=3 and 4). In this case, when phase rotations are superimposed on the beam forming phases using a plurality of elements, the phase rotations are applied to [Φ1, Φ1] to [Φ6, Φ6] with respect to a plurality of elements, respectively, whose number is six. The virtual re-radiating elements generate, with a predetermined directional beam pattern, a beam of a transmission signal (for example, a chirp signal) obtained by configuring the phase for transmission signals (for example, chirp signals), which are incident on the virtual re-radiating elements from transmitting antenna elements 113-1 and 113-2, to be phase 0 (no application of phase rotation or the application of a predetermined phase rotation serving as a reference phase), and re-radiates the generated beam.

Further, the code used in virtual re-radiating elements VE #2 formed of the elements in the two columns on the right side is code [1,−1] at times T=1 and 2 (or times T=3 and 4). In this case, when phase rotations are superimposed on the beam forming phases using a plurality of elements, the phase rotations are applied to [Φ7,−Φ7] to [Φ12,−Φ12] with respect to a plurality of elements, respectively, whose number is six. The virtual re-radiating elements generate, with a predetermined directional beam pattern, a beam of a transmission signal (for example, a chirp signal) obtained by configuring the phase for transmission signals (for example, chirp signals), which are incident on the virtual re-radiating elements from transmitting antenna elements 113-1 and 113-2, to be phase 0 (no application of phase rotation or the application of a predetermined phase rotation serving as a reference phase) or phase π (the application of a phase rotation with phase difference π with respect to the phase at “phase 0”), and re-radiates the generated beam. Further, in the same manner, virtual re-radiating elements VE #3 (or VE #4) with the respective RIS patterns of the re-radiating elements at times T=5 and 6 (or times T=7 and 8) make it possible to re-radiate a signal as a code-division multiplexed (or Doppler-division multiplexed) signal by further applying, in addition to beam forming phases Φ 1 to Φ 6 (or Φ 7 to Φ 12) using a plurality of elements, phase rotations with different codes.

Controller 114 alternately repeats the state of times T=1 to 4 and the state of times T=5 to 8. Such code-division multiplexed signals with respect to transmitting antenna elements and code-division multiplexed and time-division multiplexed signals of virtual re-radiating elements are signals orthogonal to each other, and the respective reflected waves reflected by a target can be separated and received by the radar receiver.

For this reason, the re-radiating elements re-radiate a beam which is formed based on the respective RIS patterns of the virtual re-radiating elements and on which code division multiplexing has been performed (in the case of FIG. 11B, a re-radiating signal with two RIS patterns, and the code multiplexing number of the virtual re-radiating elements is two). In addition, RIS patterns are time-divided with periods according to the code length of code division multiplexing with respect to a plurality of transmitting antenna elements (four transmission periods in the case of FIG. 11A) (in the case of FIG. 11B, two RIS patterns are switched in time division every four transmission periods, and, the time multiplexing number is two). Such a control operation, in which code division multiplexing at transmitting antenna elements and code division multiplexing and time division multiplexing at re-radiating elements are mixed, of the controller makes it possible to obtain the same effect as increasing the number of transmitting antennas in a radar by a factor of (the transmitting antenna multiplexing number×the code multiplexing number of re-radiating elements×the time multiplexing number), and to increase the number of virtual receiving antennas in a MIMO radar. It is possible to enlarge the aperture length of the virtual receiving antennas in the MIMO radar, and it is possible to improve the angle measurement performance (angle measurement estimation accuracy and angle resolution for a plurality of target objects).

Note that, directional beams by virtual re-radiating elements VE #1 to VE #4 when virtual re-radiating elements VE #1 to VE #4 are switched in time division may be configured to be directional beams that have the same directivity in time division, or may be configured to be directional beams that have different directivities. Alternatively, beam control that adaptively varies a directional beam may be used.

For example, a transmitting antenna element radiates a code-division multiplexed transmission signal. A re-radiating element code division multiplexes and re-radiates the signal, and further switches RIS patterns in time division with periods according to the code length of code division multiplexing. Note that, it may also be configured such that a plurality of elements is associated with three or more re-radiating elements.

Although Embodiment 7 makes it possible to improve the positioning performance, in particular, the angle measurement performance (angle measurement estimation accuracy and angle resolution for a plurality of target objects), of the radar apparatus with respect to a target object by combining multiplexing methods to increase the number of virtual antennas, the Doppler detection range may decrease due to the transmission of a plurality of chirp signals. In a case where the Doppler detection range of a target to be assumed is wide, it is possible to suppress the influence of a decrease in the Doppler detection range by shortening the transmission period of chirp signals. Controller 114 can select which method is used among those in Embodiment 7 and Variations 1 to 3 of Embodiment 7 according to the angle measurement performance and the Doppler detection performance. Further, controller 114 may switch, for example, the methods in Embodiment 7 and Variations 1 to 3 of Embodiment 7 according to the vehicle speed. Although a plurality of re-radiating elements is arranged in the column direction in FIGS. 10B and 11B, a plurality of re-radiating elements may be associated in the row direction or in both the row direction and the column direction rather than the column direction. For example, elements arranged in 7×5 may be associated with four re-radiating elements, and a RIS pattern in which the phase center of the re-radiating elements is moved in the row direction may also be used. Further, the number of elements that form one re-radiating element may not be 3×2.

### Embodiment 8

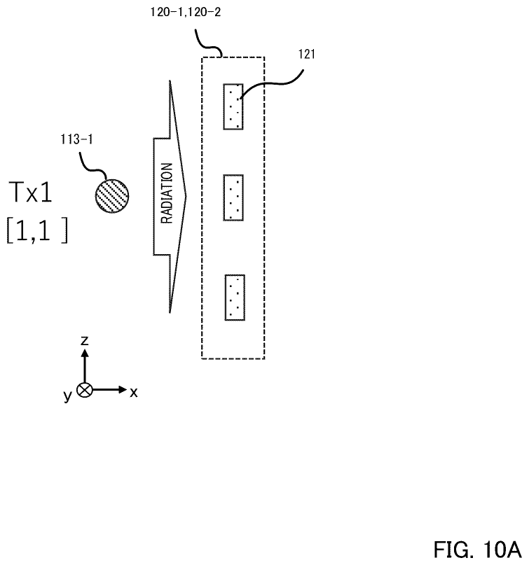

In Embodiments 1 to 7, re-radiating elements perform re-radiation by causing delays with different times. In Embodiment 8 illustrated in FIG. 12, signals transmitted by respective re-radiating elements are separated with different time delays.

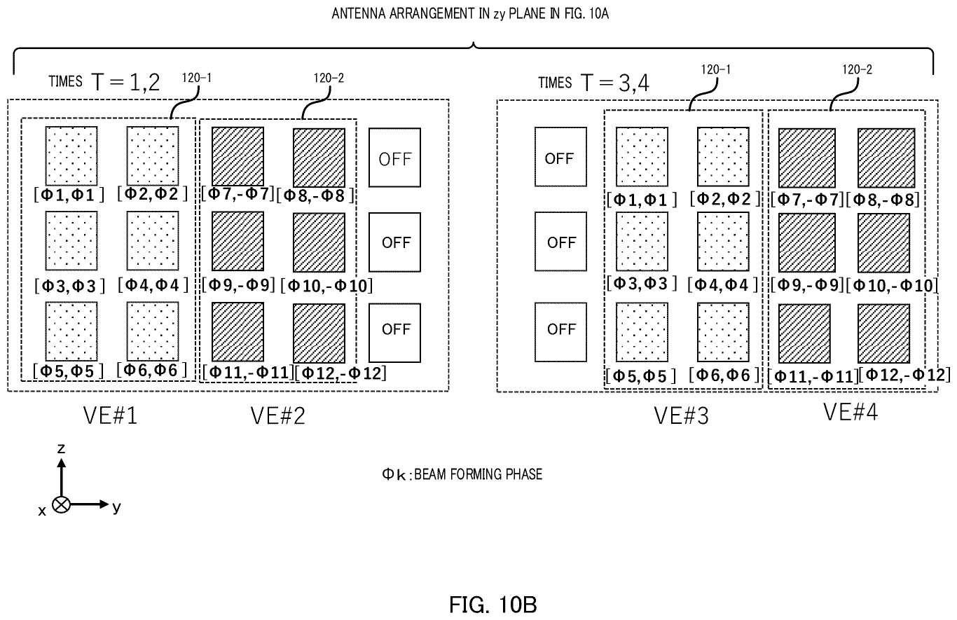

In FIG. 13, the transmitting antenna element transmits a chirp signal of transmission time T_{c} for each radar transmission period Tr.

The chirp signal that has been radiated by the transmitting antenna element is delayed with different times Tᵢ by re-radiating elements, respectively, and is re-radiated by the re-radiating elements (in the following description, Tᵢ has a shorter delay time than Tᵢ₊₁). Time Tᵢ delayed by each re-radiating element is shorter than transmission time T_{c} of a chirp signals radiated by the transmitting antenna element. Further, difference ΔT=Tᵢ₊₁−Tᵢ between times delayed by the respective re-radiating elements is greater than a time of flight (TOF) for detecting a target in maximum detection range R of the radar apparatus, for example, 2R/c (where c is the speed of light). For example, ΔT>2R/c. Note that, in a case where the re-radiating element is formed of a transparent film or the like, a transmission signal from the transmitting antenna is transmitted therethrough. In this case, time T₀ that is delayed is T₀=0 (the transmission start timing of a chirp signal), and Tᵢ is configured to be greater than the TOF of the maximum detection range.

Note that, in Embodiment 8, chirp signals that are radiated by each re-radiating element may be transmitted with different delay time differences by varying the distance between the transmitting antenna element and each re-radiating element. When time differences are provided for a chirp signal, which is radiated by the re-radiator, by varying the distance between the transmitting antenna element and each re-radiating element, it is possible to omit the control of re-radiating elements by controller 114.

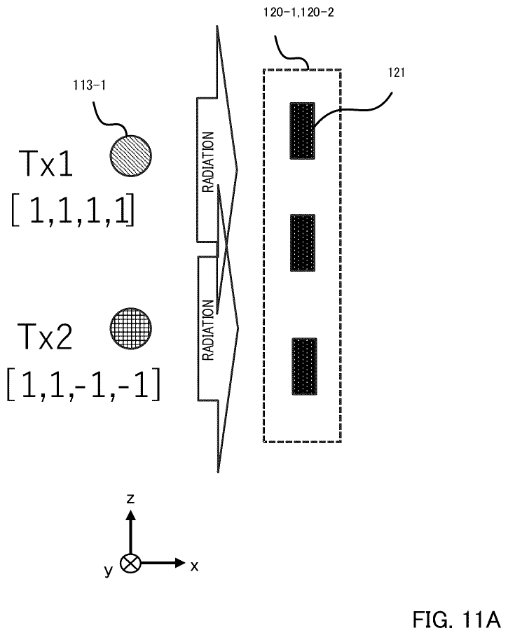

Radar receiver 119 illustrated in FIG. 14 can be combined with a multiplexing scheme using code division multiplexing (which may also be Doppler division multiplexing) and time division multiplexing described in Embodiment 7. Radar receiver 119 includes receiving antenna elements 115-1 to 115-Na, antenna system processors 1401-1 to 1401-Na, constant false alarm rate (CFAR) processor 1408, and direction estimator 1409. Antenna system processors 1401-1 to 1401-Na are associated with receiving antenna elements 115-1 to 115-Na. Each of antenna system processors 1401-1 to 1401-Na has the same configuration. Antenna system processor 1401-1 includes receiver 116 and signal processor 117. Receiver 116 includes mixer 1402 and low pass filter (LPF) 1403. Signal processor 117 includes AD converter 1404, beat frequency analyzer 1405, distance separator 1406, and Doppler analyzers 1407-1 to 1407-Loc.

Mixer 1402 receives an output of receiving antenna element 115-1 and a VCO output and outputs an output, which has been subjected to detection (mixing), to LPF 1403.

LPF 1403 extracts a beat signal included in the baseband band of the signal inputted from mixer 1402 and outputs the beat signal to AD converter 1404.

AD converter 1404 samples and quantizes the signal inputted from LPF 1403 to convert the signal into a digital signal and outputs the digital signal to beat frequency analyzer 1405.

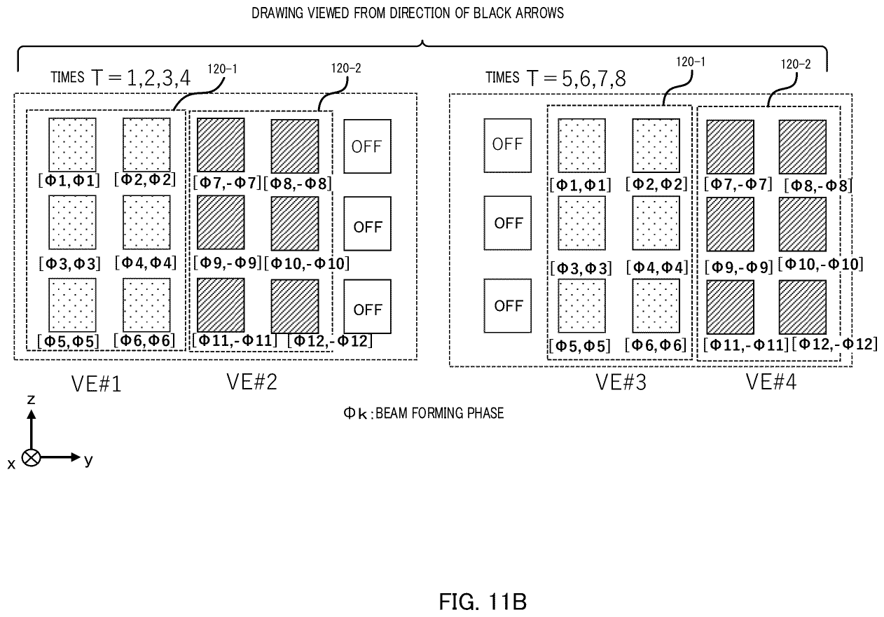

Beat frequency analyzer 1405 performs a frequency analysis on the beat signal, which is the output of AD converter 1404, for each transmission period. In the output of beat-frequency analyzer 1405, reflected signals received from respective re-radiating elements are separated for each distance block RB. In signal re-radiation, the difference between times to be delayed is configured to be greater than the TOF for detecting a target in maximum detection range R for each re-radiating element, and, signals reflected by the target can be separated and received as blocks for each radiating element. Here, distance ΔR of distance block RB (the distance to be detected by a radar) is a distance that can be detected based on the time difference between times delayed by respective re-radiating elements. For example, ΔR (Tᵢ₊₁, Tᵢ)=(Tᵢ₊₁−Tᵢ)×c/2>R. Time T₀ delayed by the transparent re-radiating element (#0) is T₀=0. FIG. 15 is a diagram provided for describing an outline of received signals from a transmitting (Tx) antenna and re-radiating elements #1 to #M and separation thereof in the output of beat frequency analyzer 1405. Beat frequency analyzer 1405 outputs received signals from re-radiating elements #1 to #M in a state in which each received signals are separated into M distance blocks RB different from each other (in a case where a received signal from the transmitting antenna is included, the received signals are separated into M+1 distance blocks RB; in FIG. 15, a received signal from the transmitting antenna is included).

Distance separator 1406 outputs the reflected signals, which have been received from beat frequency analyzer 1405 and have been separated for each distance block RB, as distances, for which the starting point of each distance block RB is used as a reference, to Doppler analyzers 1407-1 to 1407-Loc, respectively. The number Loc of Doppler analyzers is M×N, where M denotes the number of re-radiating elements and N denotes the number of transmitting antenna elements (Loc=(M+1)×N in a case where the transmitting antenna element is included). For example, distance separator 1406 outputs RB #0 to Doppler analyzer 1407-1 and outputs RB #1 to Doppler analyzer 1407-2 with respect to a transmission signal radiated by transmitting antenna #1.

Respective Doppler analyzers 1407-1 to 1407-Loc perform a Doppler analysis on the reflected signals of distance blocks RB inputted from distance separator 1406.

CFAR processor 1408 performs adaptive threshold determination by using the outputs of Loc Doppler analyzers 1407-1 to 1407-Loc and extracts distance indices and Doppler frequency indices that give peak signals.

Direction estimator 1409 performs direction estimation processing for a target object (target), by using the outputs from Loc Doppler analyzers 1407-1 to 1407-Loc, with the distance indices and the Doppler frequency indices which have been extracted by CFAR processor 1408 and give the peak signals, and positioning-outputs, as a positioning result, angle measurement information on the azimuth of the target object, the elevation angle thereof, or the like, together with distance information and Doppler information in the distance indices and the Doppler frequency indices.

### (Variation 1)

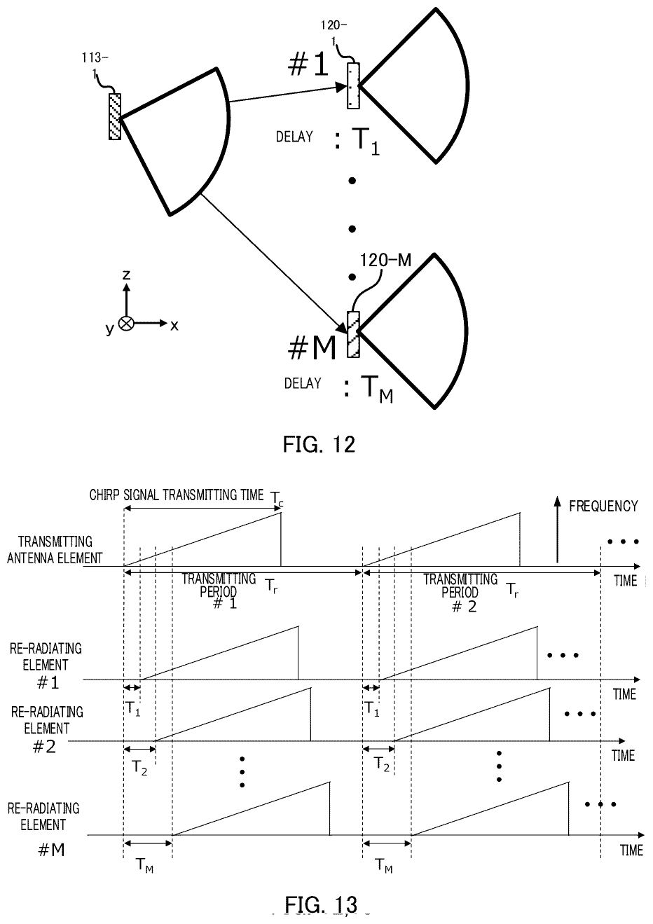

In Variation 1 of Embodiment 8 illustrated in FIG. 16, a switch included in a re-radiating element is turned on/off. For example, each re-radiating element re-radiates a transmission signal radiated by a transmitting antenna element while the switch is on, and does not re-radiate the transmission signal while the switch is off.

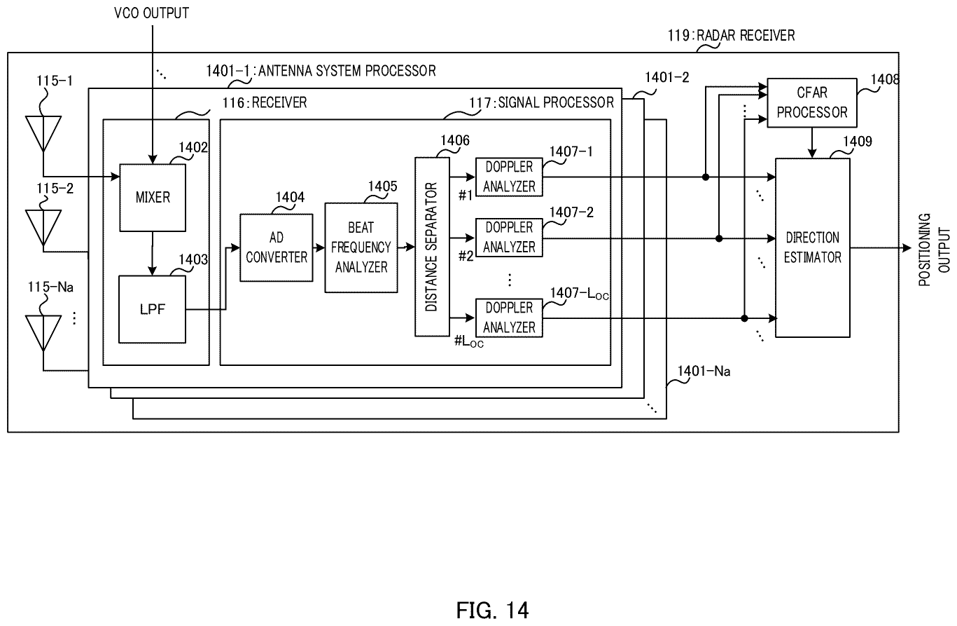

As illustrated in FIG. 17, the switches of the respective re-radiating elements are controlled by controller 114, and are sequentially turned on. Each re-radiating element is turned on after each of time delays T₁ to T_{M}, and re-radiates a transmission signal radiated by a transmitting antenna element.

### (Variation 2)

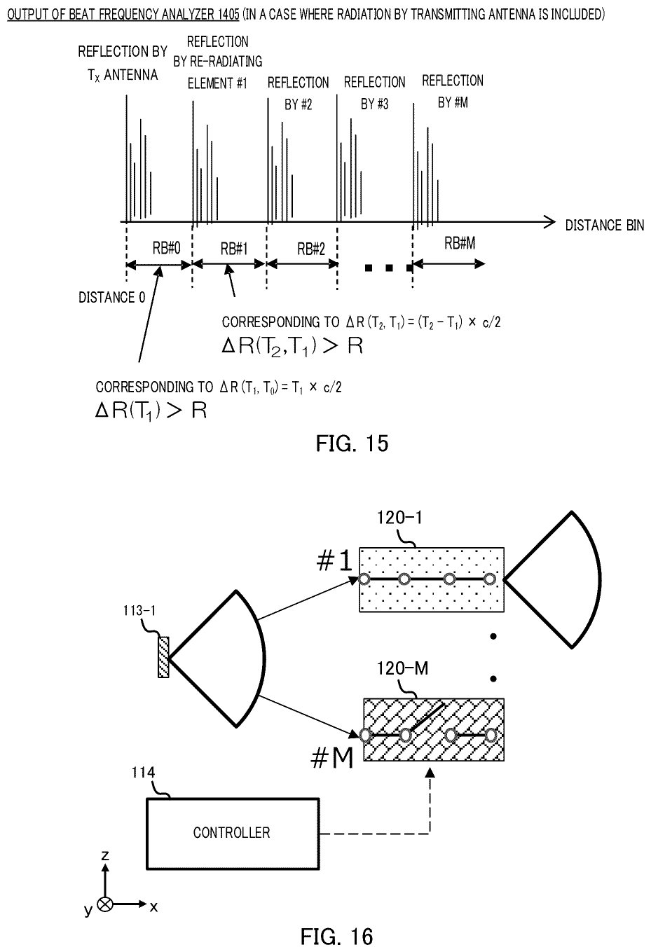

In Variation 2 of Embodiment 8 illustrated in FIG. 18, a beam of a transmission signal radiated by a transmitting antenna element is narrowed and is sequentially radiated to re-radiating elements. The timing of radiation by each re-radiating element is controlled by controlling the timings at which the transmitting antenna element radiates a transmission signal to each re-radiating element. The re-radiating element controls the directivity (beam) when performing re-radiation. All the directivities of signals radiated by re-radiating elements are the same.

### Embodiment 9

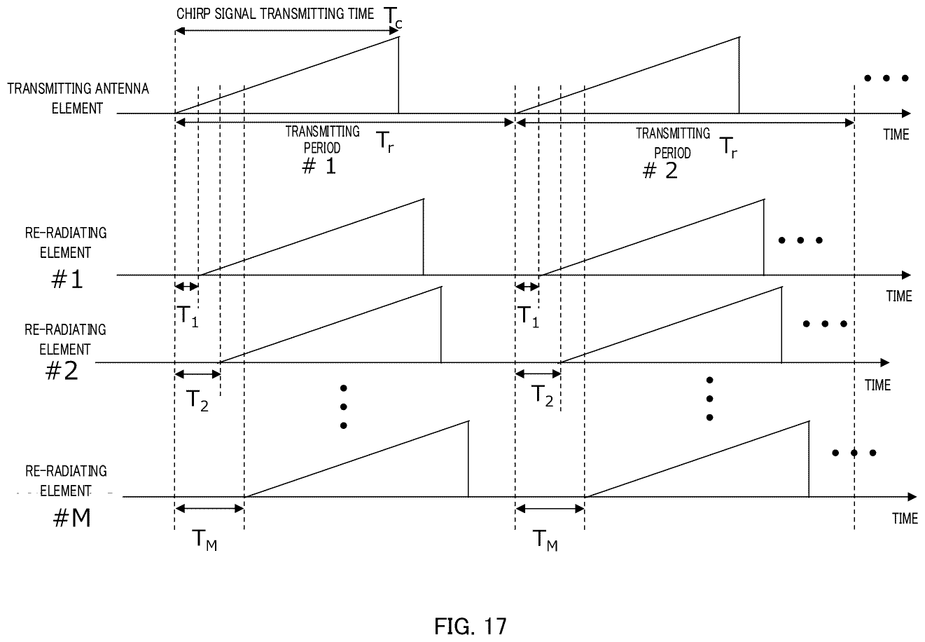

The radar apparatus according to Embodiment 9 illustrated in FIG. 19 converts polarization, with which each re-radiating element in Embodiments 1 to 8 performs radiation, into polarization orthogonal thereto (for example, vertical/horizontal polarizations, right-hand/left-hand circular polarizations). The polarization converter may convert polarization in a fixed manner or may switch polarizations, with which radiation is performed, under the control by controller 114. For example, re-radiating element 120-1 converts the polarization (for example, vertical polarization) of a transmission signal into polarization orthogonal thereto (for example, horizontal polarization) and re-radiates the transmission signal, whereas re-radiating element 120-2 (including the transparent re-radiating element) re-radiates a transmission signal without converting the polarization of the transmission signal. For example, re-radiating element 120-1 converts the polarization of a transmission signal into right-hand circular polarization and re-radiates the transmission signal, whereas re-radiating element 120-2 converts the polarization of a received transmission signal into left-hand circular polarization and re-radiates the transmission signal.

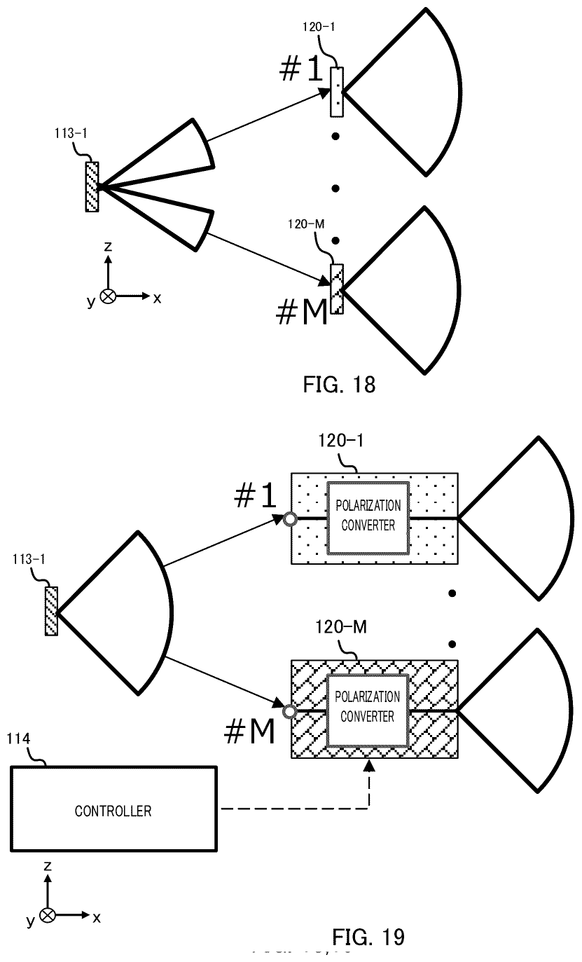

FIG. 20A is a diagram illustrating vertical polarization, FIG. 20B is a diagram illustrating horizontal polarization, FIG. 20C is a diagram illustrating right-hand circular polarization, and FIG. 20D is a diagram illustrating left-hand circular polarization, respectively.

### Embodiment 10

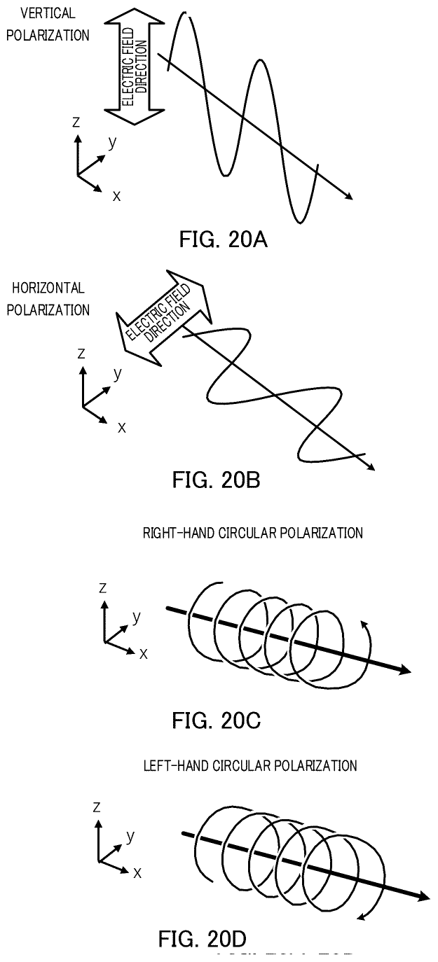

In Embodiment 10, a vehicle in which radar module 110 and re-radiator 120 in Embodiments 1 to 9 are mounted will be described with reference to FIG. 21.

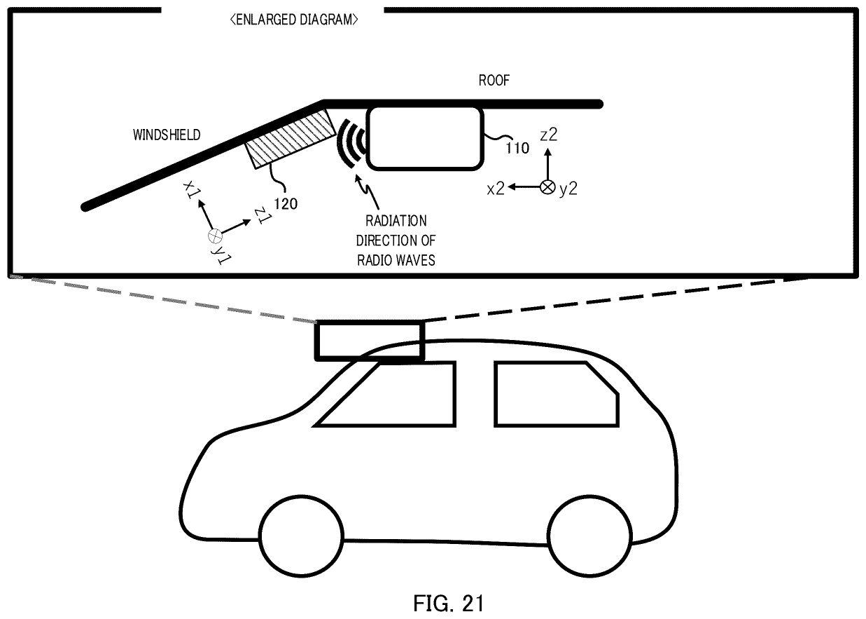

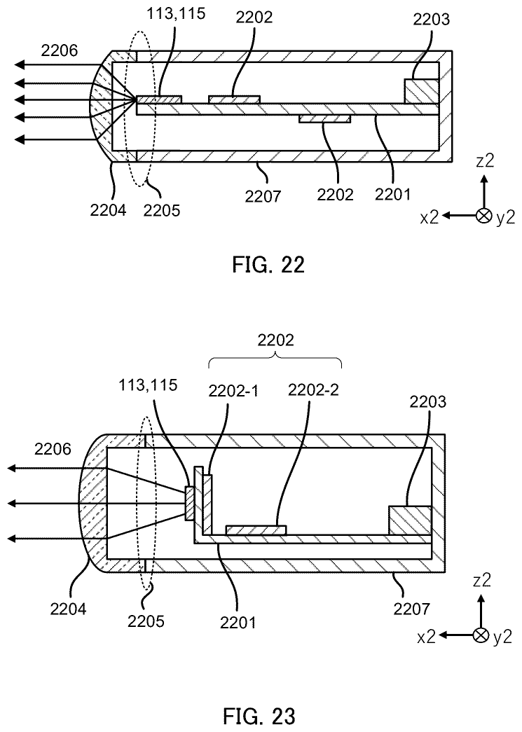

Radar module 110 is installed, inside the vehicle, in a front portion of the roof. Radar module 110 may be, for example, a thin radar apparatus including a thin end-fire antenna as illustrated in FIGS. 22 and 23 (for example, PTLs 4 and 5).

In the thin radar apparatus, housing 2207 and, in a main body formed of dielectric lens 2204 disposed in window 2205 of housing 2207, circuit board 2201, signal processing IC 2202, connector 2203, and transmitting/receiving antennas 113 and 115 are disposed. Window 2205 is a region of housing 2207, through which radio waves can be transmitted.

Signal processing IC 2202 installed on circuit board 2201 performs processing of transmission signal 2206 transmitted by transmitting/receiving antennas 113 and 115 formed of a plurality of antenna elements as well as a received signal received by the transmitting/receiving antennas, and communicates with external equipment, such as a vehicle ECU, via connector 2203. Transmitting/receiving antennas 113 and 115 are disposed at a position serving as a focal point of dielectric lens 2204. Dielectric lens 2204 converts radio waves of transmission signal 2206 into plane waves by narrowing a beam of the radio waves, radiates the plane waves to a front region outside the apparatus (the x2-axis direction), and collects received reflected signals to transmitting/receiving antennas 113 and 115. Signal-processing IC 2202 may be formed of millimeter-wave band IC 2202-1 and baseband band IC 2202-2.

Re-radiator 120 is formed, for example, on a transparent film in the z1y1 plane. By configuring re-radiator 120 to be a re-radiator in which a re-radiating element(s) is/are disposed on the transparent film, the re-radiating element(s) can be disposed anywhere on the windshield. Note that, as illustrated in FIG. 21, the x1 axis, in which re-radiator 120 is disposed, and the x2 axis, in which radar module 110 is disposed, may not be parallel to each other.

Control of the re-radiating element(s) on the transparent film is performed by controller 114 in radar module 110. Controller 114 and the re-radiating element(s) can communicate using a transparent electrode or the like on the transparent film.

Even in a case where a radar module having a lower resolution in the vertical direction (the vertical direction, the z2-axis direction) is used, the resolution in the vertical direction can be improved in combination with a re-radiating element(s).

In the embodiments described above, the notation “processor”, “ . . . er”, “ . . . or” or “ . . . ar” used for each component may be replaced with another notation such as “ . . . circuitry”, “ . . . assembly”, “ . . . device”, “ . . . unit” or “ . . . module”.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

(1) A radar apparatus in an aspect of the present disclosure includes: a radar module including a transmitting antenna that transmits a transmission signal; and a re-radiator that includes a re-radiating element that re-radiates the transmission signal.

(2) In an aspect of the present disclosure, in the radar apparatus according to (1), the re-radiator includes at least two of a plurality of the re-radiating elements.

(3) In an aspect of the present disclosure, in the radar apparatus according to (2), at least one of the plurality of re-radiating elements is a transparent re-radiating element.

(4) In an aspect of the present disclosure, in the radar apparatus according to (1), the re-radiating element is formed of an element having a metamaterial structure.

(5) In an aspect of the present disclosure, in the radar apparatus according to (1), the re-radiating element is disposed on a transparent film.

(6) In an aspect of the present disclosure, in the radar apparatus according to (4), the element having the metamaterial structure controls directivity of a re-radiating signal that is re-radiated.

(7) In an aspect of the present disclosure, in the radar apparatus according to (2), at least two re-radiating signals that are re-radiated by the at least two of the plurality of re-radiating elements, respectively, are orthogonal to each other.

(8) In an aspect of the present disclosure, in the radar apparatus according to (7), at least one of the plurality of re-radiating elements causes a delay to the transmission signal that is re-radiated.

(9) In an aspect of the present disclosure, the radar apparatus according to (8) further includes a controller that performs control such that the delay is caused to the transmission signal.

(10) In an aspect of the present disclosure, the radar apparatus according to (9) further includes a plurality of the radar modules and a plurality of the re-radiators, in which the controller controls the plurality of radar modules and the plurality of re-radiators.

(11) In an aspect of the present disclosure, in the radar apparatus according to (1), the re-radiator includes the re-radiating element that is formed of a plurality of elements having a metamaterial structure, and the radar apparatus further includes a controller that performs control in time division such that the plurality of elements is turned on or off.

(12) In an aspect of the present disclosure, in the radar apparatus according to (4), the re-radiator includes the re-radiating element that is formed of a plurality of the elements having the metamaterial structure, and the re-radiating element that is formed of the plurality of elements having the metamaterial structure forms and outputs a predetermined beam.

(13) In an aspect of the present disclosure, in the radar apparatus according to (11), the transmitting antenna includes a plurality of transmitting antenna elements, and the plurality of transmitting antenna elements transmits the transmission signal that is code-division multiplexed or Doppler-division multiplexed.

(14) In an aspect of the present disclosure, in the radar apparatus according to (11) or (12), the transmitting antenna includes a plurality of transmitting antenna elements, and the plurality of elements having the metamaterial structure code-division multiplexes or Doppler-division multiplexes a re-radiating signal that is re-radiated.

(15) In an aspect of the present disclosure, in the radar apparatus according to (11) or (12), the transmitting antenna includes a plurality of transmitting antenna elements, the plurality of transmitting antenna elements transmits the transmission signal that is Doppler-division multiplexed, and the plurality of elements having the metamaterial structure code-division multiplexes a re-radiating signal that is re-radiated.

(16) In an aspect of the present disclosure, in the radar apparatus according to (14) or (15), the re-radiator includes at least two of a plurality of the re-radiating elements each of which is formed of the plurality of elements having the metamaterial structure.

(17) In an aspect of the present disclosure, in the radar apparatus according to (8), the transmission signal is a chirp signal, and the delay is a delay based on a maximum detection range of the radar apparatus.

(18) In an aspect of the present disclosure, in the radar apparatus according to (17), the re-radiator includes the plurality of re-radiating elements, the transmission signal is the chirp signal, and a time difference in which the delay is caused to the transmission signal between two of the plurality of re-radiating elements is greater than twice a value obtained by dividing the maximum detection range of the radar apparatus by speed of light.

(19) In an aspect of the present disclosure, in the radar apparatus according to (18), the radar module separates, based on the delay, a reflected signal, which is the transmission signal reflected by a target, and a reflected signal, which is each of the at least two re-radiating signals, where the each of the at least two re-radiating signals is re-radiated by each of the plurality of re-radiating elements and reflected by the target.

(20) In an aspect of the present disclosure, in the radar apparatus according to (9), the re-radiator includes at least one switch corresponding to the at least one of the plurality of re-radiating elements, and the controller controls the at least one switch such that the delay is caused to the transmission signal.

(21) In an aspect of the present disclosure, in the radar apparatus according to (7), the re-radiator includes the plurality of re-radiating elements, and the transmitting antenna changes directivity and sequentially radiates the transmissions signal to the plurality of re-radiating elements.

(22) In an aspect of the present disclosure, in the radar apparatus according to (2), the plurality of re-radiating elements re-radiates the transmission signal with polarizations orthogonal to each other.

(23) A vehicle in an aspect of the present disclosure is a vehicle in which the radar apparatus according to (1) is mounted.

(24) In an aspect of the present disclosure, on the vehicle according to (23), the radar module is installed on a roof of the vehicle, and the re-radiator is installed in a windshield of the vehicle.

While various embodiments have been described herein above, it is to be appreciated that various changes in form and detail may be made without departing from the spirit and scope of the invention(s) presently or hereafter claimed.

The disclosure of Japanese Patent Application No. 2024-090848, filed Jun. 4, 2024, including the specification, drawings and abstract, is incorporated herein by reference in its entirety.

### INDUSTRIAL APPLICABILITY

The present disclosure is useful for a radar apparatus and a vehicle.

### REFERENCE SIGNS LIST

110 Radar module
111 Radar transmission signal generator
112 Transmitter
113 Transmitting antenna
113-1 to 113-N Transmitting antenna element
114 Controller
115 Receiving antenna
116 Receiver
117 Signal processor
118 Radar transmitter
119 Radar receiver
120 Re-radiator
120-1 to 120-M Re-radiating element
130 Target
140 Integrated controller
1401 Antenna system processor
1402 Mixer
1403 LPF
1404 AD converter
1405 Beat frequency analyzer
1406 Distance separator
1407 Doppler analyzer
1408 CFAR processor
1409 Direction estimator
2201 Circuit board
2202 Signal processing IC
2202-1 Millimeter-wave band IC
2202-2 Baseband band IC
2203 Connector
2204 Dielectric lens
2205 Window
2206 Transmission signal
2207 Housing

1. A radar apparatus, comprising:
a radar module including a transmitting antenna which, in operation, transmits a transmission signal; and
a re-radiator including one or more re-radiating elements which, in operation, re-radiates the transmission signal as a re-radiating signal.

2. The radar apparatus according to claim 1, wherein
at least one of the one or more re-radiating elements is a transparent re-radiating element.

3. The radar apparatus according to claim 1, wherein
at least one of the one or more re-radiating elements is formed of an element having a metamaterial structure.

4. The radar apparatus according to claim 1, wherein
at least one of one or more re-radiating elements is disposed on a transparent film.

5. The radar apparatus according to claim 3, wherein
the element having the metamaterial structure which, in operation, controls directivity of the re-radiating signal.

6. The radar apparatus according to claim 1, wherein
a first re-radiating signal by a first re-radiating element of the one or more re-radiating elements and a second re-radiating signal by a second re-radiating element of the one or more re-radiating elements are orthogonal to each other.

7. The radar apparatus according to claim 1,
a first re-radiating signal by a first re-radiating element of the one or more re-radiating elements and a second re-radiating signal by a second re-radiating element of the one or more re-radiating elements are re-radiated at different timings.

8. The radar apparatus according to claim 1, wherein:
the radar module is a plurality of radar modules,
the re-radiator is a plurality of re-radiators, and
the radar apparatus further includes a control circuitry which, in operation, controls the plurality of radar modules and the plurality of re-radiators.

9. The radar apparatus according to claim 3, wherein:
the re-radiator includes the at least one of the one or more re-radiating elements each of which is formed of a plurality of the elements having the metamaterial structure, and
the radar apparatus further includes a control circuitry which, in operation, switches in time division at least one element which turns on among the plurality of elements having the metamaterial structure.

10. The radar apparatus according to claim 3, wherein
the re-radiator includes the at least one of the one or more re-radiating elements each of which is formed of a plurality of elements having the metamaterial structure, and
the at least one of the one or more re-radiating elements each of which is formed of the plurality of elements having the metamaterial structure forms and outputs a predetermined beam.

11. The radar apparatus according to claim 9, wherein:
the transmitting antenna includes a plurality of transmitting antenna elements, and
the plurality of transmitting antenna elements which, in operation, transmits the transmission signal that is code-division multiplexed or Doppler-division multiplexed.

12. The radar apparatus according to claim 9, wherein:
the transmitting antenna includes a plurality of transmitting antenna elements, and
the plurality of elements having the metamaterial structure code-division multiplexes or Doppler-division multiplexes the re-radiating signal.

13. The radar apparatus according to claim 7, wherein:
the transmission signal is a chirp signal, and
the delay is a delay based on a maximum detection range of the radar apparatus.

14. The radar apparatus according to claim 13, wherein:
the re-radiator includes the plurality of re-radiating elements,
the transmission signal is the chirp signal, and
a time difference is greater than twice a value obtained by dividing the maximum detection range of the radar apparatus by speed of light, the time difference being a time difference in which the delay is caused to the re-radiating signal between two of the plurality of re-radiating elements.

15. The radar apparatus according to claim 14, wherein
the radar module separates, based on the delay, a reflected signal, which is the transmission signal reflected by a target, and a reflected signal, which is the re-radiating signal re-radiated by each of the one or more of re-radiating elements and reflected by the target.

16. The radar apparatus according to claim 1, wherein:
the re-radiator includes at least one switch corresponding to the at least one of the one or more re-radiating elements, and
the radar apparatus further includes a control circuitry which, in operation, delays the re-radiating signal by controlling the at least one switch.

17. The radar apparatus according to claim 1, wherein
the re-radiator includes the plurality of re-radiating elements, and
the transmitting antenna which, in operation, changes directivity and sequentially radiates the transmission signal to the plurality of re-radiating elements.

18. The radar apparatus according to claim 1, wherein
the plurality of re-radiating elements which, in operation, re-radiates the transmission signal with polarizations orthogonal to each other.

19. A vehicle in which a radar apparatus configured to be mounted, wherein
the radar apparatus includes:
a radar module including a transmitting antenna which, in operation, transmits a transmission signal; and
a re-radiator including one or more of re-radiating elements which, in operation, re-radiates the transmission signal as a re-radiating signal.

20. The vehicle according to claim 19, wherein:
the radar module is configured to be mounted on a roof of the vehicle, and
the re-radiator is configured to be mounted on a windshield of the vehicle.
